(19) United States
(12) Patent Application Publication
(10) Pub. No.: US 2015/0282139 A1
(43) Pub. Date: Oct. 1, 2015

(54) METHOD IN A NETWORK NODE AND METHOD IN A TELECOMMUNICATION SYSTEM FOR CELL EDGE BAND ALLOCATION AND NETWORK NODE

(71) Applicant: TELEFONAKTIEBOLAGET L M ERICSSON (PUBL), Stockhom (SE)

(72) Inventors: Ying Sun, Sundbyberg (SE); Zelimir Bajzec, Sundbyberg (SE)

(21) Appl. No.: 14/428,913

(22) PCT Filed: Sep. 18, 2012
(86) PCT No.: PCT/SE2012/050985

§ 371 Date: Mar. 17, 2015

(51) Int. Cl. H04W 72/04; H04W 16/14; H04L 5/00

(52) U.S. Cl. CPC H04W 72/044; H04L 5/0035; H04W 16/14; H04W 72/082

(57) ABSTRACT

The technology disclosed herein relates to a method in a telecommunication system for cell edge band allocation and a network node within the telecommunication system. The method comprises allocating a first frequency band within the first frequency bandwidth as a cell edge band for uplink transmission during a first allocation time period and allocating a second frequency band different from the first frequency band within the first frequency bandwidth as the cell edge band for uplink transmission during a second allocation time period. The processing unit is configured to allocate a first frequency band within the first frequency bandwidth as a cell edge band for uplink transmission during a first allocation time period and to allocate a second frequency band different from the first frequency band within the first frequency bandwidth as the cell edge band for uplink transmission during a second allocation time period.

### TECHNICAL FIELD

The technology disclosed herein relates generally to the field of wireless communication systems, and in particular to a method in a node of a wireless communication system and a method in a telecommunication system for cell edge band allocation and a network node within the telecommunication system.

### BACKGROUND

Single-carrier frequency division multiple access (SC-FDMA) is a modified form of Orthogonal FDMA (OFDMA) and adopted in Long Term Evolution (LTE) uplink transmission. SC-FDMA is also often referred to as Discrete Fourier Transform Spread (DFTS)-Orthogonal frequency-division multiplexing(OFDM).

DFTS-OFDM can be interpreted as normal OFDM with a DFT-based precoding. Similar to OFDM modulation, DFTS-OFDM relies on block-based signal generation. In case of DFTS-OFDM, a block of M modulation symbols is first applied to a size-M DFT. The output of the DFT is then applied to consecutive inputs (subcarriers) of an OFDM modulator. With OFDM and DFTS-OFDM the available frequency bandwidth is divided into 15 kHz subcarriers, whereby a group of 12 subcarriers forms a resource block (RB).

In SC-FDMA uplink cellular systems, interference arising from terminals in neighboring cells degrades system performance, especially the performance of cell-edge terminals. To overcome this drawback, Fractional Frequency Reuse (FRR) has been studied, e.g. in [1] Fushiki et al., Throughput Gain of Fractional Frequency Reuse with Frequency Selective Scheduling in SC-FDMA Uplink Cellular System, IEEE 2011.

In SC-FDMA uplink cellular systems, the universal frequency reuse with a frequency reuse factor of one is expected from the perspective of achieving high spectral efficiency. However, the universal frequency reuse will introduce significant inter-cell interference among neighboring cells if the same frequency portions are assigned to different terminals in neighboring cells. This leads to a degradation in system performance, especially for terminals near a cell edge (hereafter called cell-edge terminals). To overcome this drawback, inter-cell interference coordination (ICIC) has been included as a Radio Resource Management (RRM) aspect of UTRAN LTE since Release 8. The aim of ICIC is to lower inter-cell interference by coordinating the reuse of spectrum resources among neighboring cells.

Fractional Frequency Reuse (FRR) is one of the methods that have been suggested for ICIC, e.g. in [1].

According to FRR, the usage of the spectrum resource PRB is restricted such that the uplink transmission in a serving cell does not collide, or has less probability to collide, with the uplink transmission in neighboring cells. FRR can reduce the effect of inter-cell interference and the Signal to interference and noise ration (SINR) for cell-edge terminals by assigning different frequency portions to the cell-edge terminals among neighboring cells.

While it is possible to obtain a large SINR improvement for cell-edge terminals by eliminating Inter-cell interference (ICI) the SINR improvement will be smaller for cell-center terminals, as the ICI is not as dominant for these terminals. Therefore, it is not bandwidth efficient to use the same frequency-reuse factor (FRF) value for the entire cell. One way to improve the cell-edge SINR while maintaining a good spectral efficiency is to use an FRF greater than 1 for the cell-edge regions and an FRF of 1 for the cell-center regions. Such an FFR scheme is illustrated in FIG. 1.

In the example of FIG. 1, the entire bandwidth is divided into four segments {f1, f2, f3, f4}. f1 is used for the cell-center regions (11) with an FRF value of 1, while f2, f3 and f4 are used for an FRF of 3 configuration for the cell-edge regions (12).

FIG. 2 shows an example of how spectrum utilization is improved in comparison to the example given in FIG. 1. The spectrum, i.e. the frequency bandwidth for uplink transmission available in the serving cell, is split into three non-overlapping segments {f1, f2, f3}. These segments are used for uplink transmission of terminals located within cell-edge regions (22). Since different segments of the available frequency bandwidth are allocated to potentially interfering terminals for uplink transmission, interference is avoided or reduced and the SINR of terminals located in the cell-edge area is increased. Terminals located in the center center area (21) (hereafter called cell-center terminals) generate and experience less interference with the neighboring cells. For these terminals it is in general possible to allocate the entire available frequency bandwidth, i.e. f1, f2 and f3, for uplink transmission, thus allowing transmission of high data rates. FRR is more efficient in low load situations where the spectrum is not fully utilized and the interference can be minimized by partially allocating the frequency resource in different parts of the spectrum as illustrated in the examples given in FIGS. 1 and 2.

It is an object of the present disclosure to further improve the spectrum efficiency and, at the same time, retaining a high SINR for cell-edge terminals.

### SUMMARY

This object is, according to a first aspect, achieved by a method in a first node of a wireless telecommunication system. The first node serves terminals located within a first cell of the telecommunication system. A first frequency bandwidth for uplink transmission of the terminals within the cell is allocated to the node. The method comprises allocating a first frequency band within the first frequency bandwidth as a cell edge band for uplink transmission during a first allocation time period and allocating a second frequency band different from the first frequency band within the first frequency bandwidth as the cell edge band for uplink transmission during a second allocation time period.

According to a second aspect, this object is achieved by a method in a telecommunication system. The telecommunications system comprises a first node serving terminals located within a first cell of the telecommunication system and being allocated a first frequency bandwidth for uplink transmission of the terminals within the first cell and a second node serving terminals located within a second cell of the telecommunication system and being allocated the first frequency bandwidth for uplink transmission of the terminals within the second cell. The method comprises during a first allocation time period allocating a first frequency band within the first frequency bandwidth as a first cell edge band for uplink transmission for terminals located within the first cell and close to a cell boarder of the first cell. The method further comprises during the first allocation time period allocating a second frequency band different from the first frequency band within the first frequency bandwidth as a second cell edge band for uplink transmission for terminals within the second cell and close to a cell boarder of the second cell. The method further comprises during a second allocation time period allocating the second frequency band as the first cell edge band for uplink transmission for terminals located within the first cell and close to a cell boarder of the first cell.

According to a third aspect, this object is achieved by a network node within a telecommunication system. The network node comprises a processing unit and a memory. The processing unit is configured to allocate a first frequency band (f1) within the first frequency bandwidth (fB) as a cell edge band for uplink transmission during a first allocation time period and to allocate a second frequency band (f2) different from the first frequency band (f1) within the first frequency bandwidth (fB) as the cell edge band for uplink transmission during a second allocation time period.

### BRIEF DESCRIPTION OF THE DRAWINGS

FIG. 1 illustrates schematically a conventional fractional frequency reuse solution in a telecommunication system.

FIG. 2 illustrates schematically another and improved conventional solution for fractional frequency reuse within a telecommunication system.

FIG. 3 illustrates resource block allocation for uplink transmission in a system according to FIG. 2.

FIG. 4 is a flow chart of an embodiment of a method performed in a network node.

FIG. 5 is an example embodiment of cell edge band allocation in a cell in accordance with the method as illustrated in FIG. 4.

FIG. 6 is an illustration how cell edge band frequency allocation may be coordinated between different cells in order to avoid or reduce interference during uplink transmission.

FIG. 7 shows an example how allocation time periods may be determined in dependence of cell statistic parameters.

FIG. 8 shows a flowchart of an example method for cell edge band frequency allocation within a telecommunication system.

FIG. 9 shows an example of the employment of an embodiment of a method in cells with overlapping coverage.

FIG. 10 illustrates an exemplifying network node comprising means for implementing embodiments of the methods.

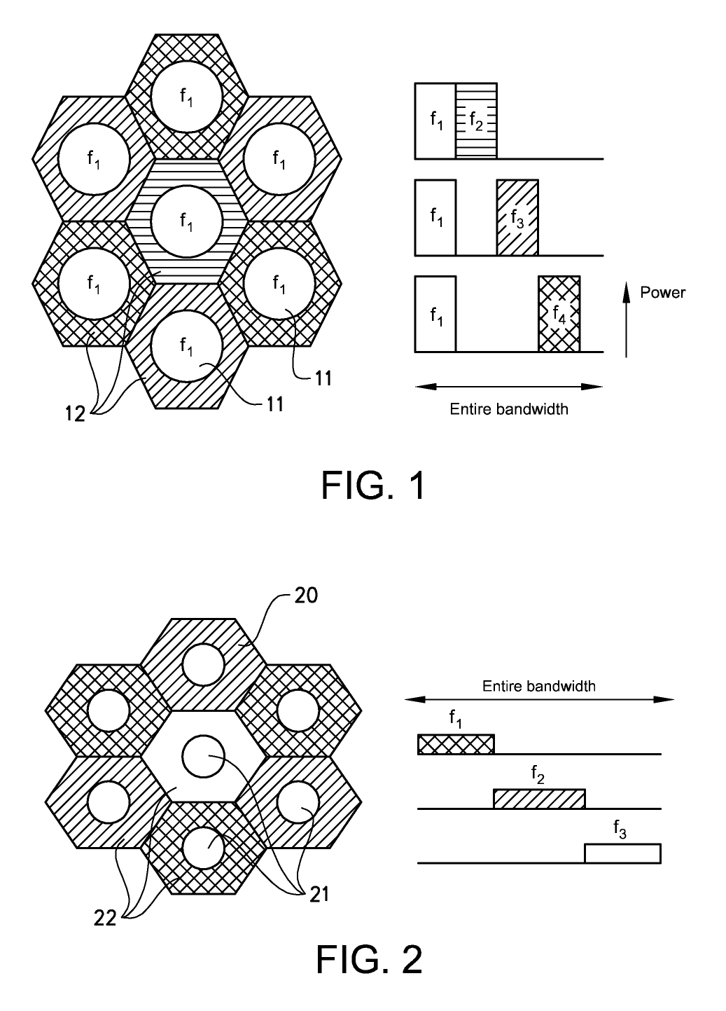

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

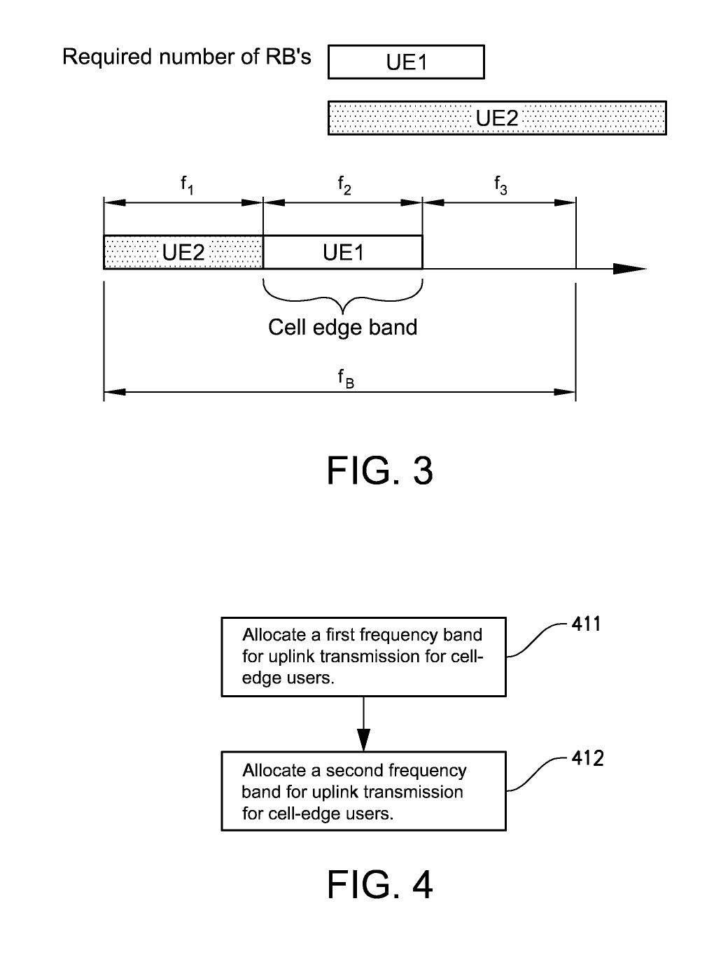

The inventors have realized that a problem with the solution as illustrated in FIG. 2 is that the available frequency bandwidth may be fragmented by the frequency allocation for the cell-edge users. Referring back to the example given in FIG. 2, the available frequency bandwidth is divided into three different frequency bands f1, f2 and f3. The inventors have further realized that an allocation of the frequency band f2 as cell edge band for uplink transmission for terminals within the cell and located close to a cell boarder of that cell causes a fragmentation of the available frequency bandwidth. FIG. 3 will serve for the purpose of further illustration of the cause and the effects of this fragmentation of the available bandwidth with reference to cell 20 in FIG. 2.

Referring to FIG. 3, terminal UE1 is a terminal located in the cell-edge region of a serving cell 20 while terminal UE2 is a terminal located in the cell-center region of the serving cell 20 as illustrated in FIG. 2. The frequency band f2 is allocated as cell-edge band for uplink transmission for this serving cell. In FIG. 3 it is also indicated the number of RB's needed within a particular time transmission interval (TTI) for cell-edge terminal UE1 and cell-center terminal UE2 for uplink transmission.

Uplink transmission for UE1 is performed using RB's within the allocated cell edge band f2. The cell-center terminal UE2 would, in general, be able to perform uplink transmission using the entire frequency bandwidth fB. However, since the frequency band f2 is dedicated for cell edge users and UE1 is in uplink transmission using the allocated cell edge frequency band f2, uplink transmission for cell-center terminal UE2 is limited to the RB's of frequency band f1 while frequency band f3 remains unused for this TTI. The reason for this limitation is that uplink transmission using SC-FDMA is restricted to consecutive RB's. If a cell edge user UE1 is allocated a cell edge band in the middle part of the available frequency band, the cell center user UE2 cannot utilize the complete spectrum, thereby avoiding higher throughput data rates in the uplink for cell center users.

In order to further improve the throughput data rates in the uplink, a time-frequency fractional frequency reuse coordination scheme it proposed. The proposed scheme is in particular suitable, but not limited to, LTE uplink transmission.

FIG. 4 illustrates how the proposed time-frequency fractional frequency reuse coordination scheme may be implemented as a method in a network node serving terminals located within a cell, e.g. an eNodeB, a Node B or a base transceiver station (BTS). For the node a frequency bandwidth fB is allocated for uplink transmission of terminals to the network node. During a first allocation time period t1, the network node allocates (411) a first frequency band f1 within the frequency bandwidth fB as a cell edge band for uplink transmission. During a second allocation time period t2, the network node allocates (412) a second frequency band f2 within the frequency bandwidth fB and different from the first frequency band f1 as a cell edge band for uplink transmission.

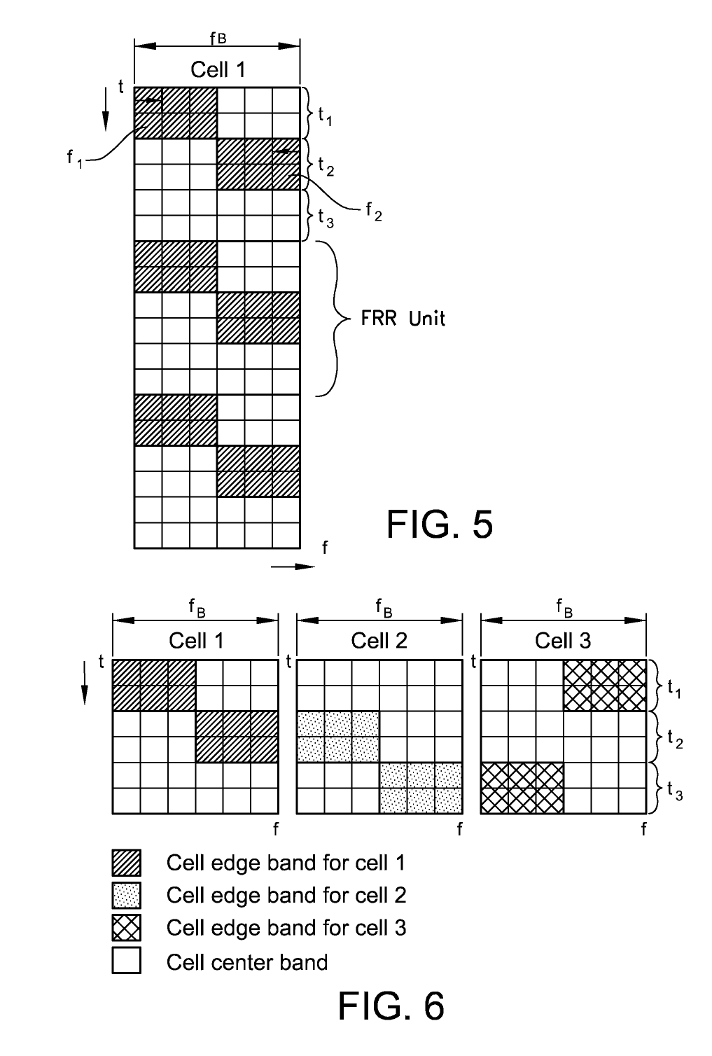

In FIG. 5 an example of cell edge band frequency allocation over time in accordance with the method presented in FIG. 4 is given for a cell 1 within a telecommunication system. The frequency bandwidth fB is allocated to the cell for uplink transmission.

During a first allocation time period t1, a first frequency band f1 within the frequency bandwidth fB is allocated for cell-edge uplink transmission for the cell 1. The first allocation time period t1 is a first number n1 of time transmission intervals (TTI), whereby n1 is equal to or larger than 1.

During a second allocation time period t2, a second frequency band f2 is allocated for cell edge uplink transmission for the cell 1. The second allocation time period is as second number n2 of TTI, whereby n2 is equal or larger than 1.

During a third allocation time period t3, no frequency band is allocated for cell edge uplink transmission. Accordingly, during the third allocation time period the entire allocated frequency bandwidth fB can be used for uplink transmission by cell center users, while cell edge users are not able to transmit during the third allocation time period t3. The third allocation time period is a third number n3 of TTi, whereby n3 is equal or larger than 1.

After the third allocation time period t3, the cell edge band allocation scheme may be repeated and start again with the first allocation time period t1.

In the example shown in FIG. 5, the first allocated frequency band f1 extends over half of the frequency bandwidth fB, starting from and including the lowest frequency value within the allocated frequency bandwidth fB. The second allocated frequency band f2 extends also over half of the allocated frequency bandwidth fB starting from and including the highest frequency value of the allocated frequency bandwidth fB. In this configuration, the same cell edge band fraction as in the traditional FRR configuration shown in FIG. 2 are achieved, i.e. one third of the available time-frequency resources for uplink transmission within the cell is allocated to cell-edge users. Cell center users can be allocated in the cell center frequency region and as well in the cell edge band, i.e. uplink transmission for cell center users is possible over the entire available frequency bandwidth if no cell edge terminal is transmitting within the allocated cell edge band. When there is cell edge user frequency allocation during a allocation time period, e.g. one TTI, half of the available frequency spectrum is dedicated to cell edge users for uplink transmission. Overall in time and frequency, one third of the available frequency resources within the cell are dedicated for cell edge users.

The duration of the first, second and/or third allocation time period may be determined responsive to at least a first cell statistic parameter. Such a feature can be realized with Self-Organizing Networks (SON) as known in the art and e.g. specified in 3GPP TS 32.500 “Telecommunication management; Self-Organizing Networks (SON); Concepts and requirements (Rel. 8); December 2008. An example as a cell statistic parameter to be used when determining the first, second and/or third allocation time period is the number of cell edge users in comparison to the number of users in the cell or the absolute number of cell edge users. Referring to the example in FIG. 5, when a cell has a large number of cell edge users, this will cause more interference, and the first and/or second allocation time period may be increased while the third allocation time period when no frequency band is allocated as cell edge band may be decreased. In contrast, if the number of cell edge users is low, then the first allocation time period t1 and/or the second allocation time period t2 may be decreased while the third allocation time period t3 may be increased.

In the example illustrated in FIG. 5 the first frequency band f1 and the second frequency band f2 each extend over half of the available bandwidth fB. However, other extensions of the first and/or second frequency band are possible and may be determined and realized responsive to cell statistic parameters and/or with SON as described above. An example for a cell statistic parameter to be used when determining the extension of the first and/or second frequency band are the number of cell edge users in comparison to the number of users in the cell or the absolute number of cell edge users in the cell. If the number of cell edge terminals is small in comparison to the number of cell center terminals then a frequency band extending over less than half of the available bandwidth fB, e.g. extending over 25% of the available bandwidth fB, may be allocated as the first frequency band f1 and/or as the second frequency band f2.

As the example in FIG. 5 shows, the first, second and third allocation time periods together form a FRR unit. An FRR unit may, however, be divided into another number of allocation time periods, e.g. four allocation time periods or five allocation time periods. In general, the number of allocation time periods depends on the frequency reuse factor, FRF, and may advantageously be equal or a multiple of the FRF, although another number of allocation time periods is alternatively possible. In the example given in FIG. 5, the FRF is 3, which results in 3 different allocation time periods.

While FIG. 5 illustrates an example of the cell edge band frequency allocation scheme for a single cell 1, FIG. 6 illustrates how the cell edge band frequency allocation may be coordinated between different cells in order to avoid or reduce cell edge interference during uplink transmission.

During a first allocation time period t1, a lower half of the available frequency bandwidth fB is allocated as cell edge band for uplink transmission for cell edge users in cell 1 while the upper half of the available frequency bandwidth fB is allocated as cell edge band for uplink transmission for cell edge users in cell 3. During the first allocation time period t1, no cell edge band is allocated for uplink transmission for cell edge terminals in cell 2. The entire available frequency bandwidth fB may in cell 2 be used for uplink transmission for cell center users. The remaining half of the available frequency bandwidth fB in both cell 1 and 3 may used for uplink transmission of cell center terminals. If the allocated cell edge band in cells 1 or 3 is not used for uplink transmission of any cell edge terminal during the first allocation time period t1 then cell center users may perform uplink transmission over the entire available frequency bandwidth fB.

During a second allocation time period t2, the upper half of the available frequency bandwidth fB is allocated as cell edge band for uplink transmission for cell edge users in cell 1 while a lower half of the available frequency bandwidth fB is allocated as cell edge band for uplink transmission for cell edge users in cell 2. During the second allocation time period t2, no cell edge band is allocated for uplink transmission for cell edge terminals in cell 3. The entire available frequency bandwidth fB may in cell 3 be used for uplink transmission for cell center users. The remaining half of the available frequency bandwidth fB in both cell 1 and 2 may be used for uplink transmission of cell center terminals. If the allocated cell edge band in cells 1 or 2 is not used for uplink transmission of any cell edge terminal during the first allocation time period then cell center users may perform uplink transmission over the entire available frequency bandwidth fB.

During a third allocation time period t3, no cell edge band is allocated for uplink transmission for cell edge terminals in cell 1. The entire available frequency bandwidth fB may in cell 1 be used for uplink transmission for cell center users.

During the same third allocation time period t3, a lower half of the available frequency bandwidth fB is allocated as cell edge band for uplink transmission for cell edge users in cell 3, while the upper half of the available frequency bandwidth fB is allocated as cell edge band for uplink transmission for cell edge users in cell 2. The remaining half of the available frequency bandwidth fB in both cell 2 and 3 may used for uplink transmission of cell center terminals. If the allocated cell edge band in cells 2 or 3 is not used for uplink transmission of any cell edge terminal during the first allocation time period then cell center users may perform uplink transmission over the entire available frequency bandwidth.

After the third allocation time period, the cell edge band allocation scheme is repeated and starts again with the first allocation time period for each of the cells 1-3.

The features for determining the duration of the allocation time periods and/or the extension of cell edge bands in relation to the available frequency bandwidth responsive to cell statistic parameters and/or SON described with reference to FIG. 5 relating to a single cell 1 may naturally be applied to each of the cells 1-3 and to the entire system of the three cells. It shall be emphasized that the number of 3 cells has only been chosen by way of example, while the disclosed method might be applied to any other number of cells as long as the number of cells is equal or larger than two. In particular, the use of cell statistic parameters and SON as described in connection with FIG. 5 may be applied to each of the three cells in order to further optimize uplink transmission and uplink transmission data rate and frequency bandwidth efficiency.

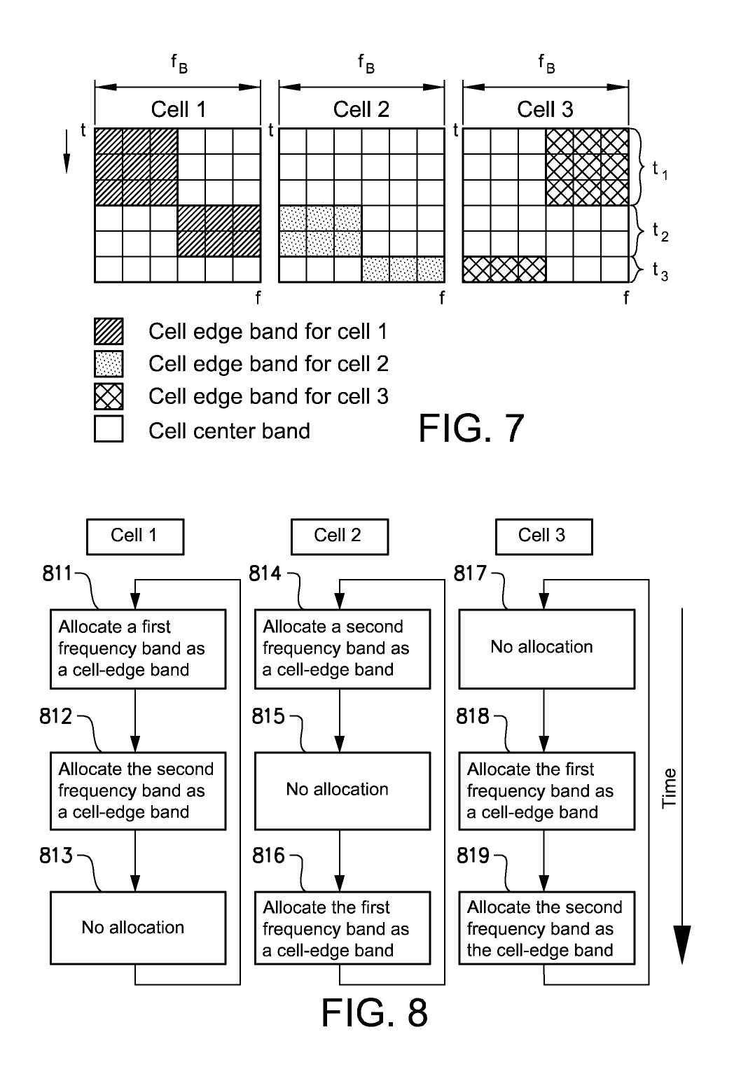

FIG. 7 illustrates an example how the allocation time periods may be determined in dependence of cell statistic parameters. In the example given in FIG. 7, Cell 1 has a large number of cell edge terminals, Cell 3 has a smaller number of cell edge terminals and Cell 2 has only a small number of cell edge users. The cell edge band allocation scheme for cells 1, 2 and 3 follows the same general principle as already described in relation to FIG. 6. However, due to the different number of cell edge users in the cells the first allocation time period t1 (a cell edge band is only allocated to cell edge terminals located in cell 1 or cell 3; no cell edge band is allocated to cell edge terminals in cell 2) is longer and maybe e.g. 3 TTI. The second allocation time period t2 (a cell edge band is only allocated to cell edge terminals located in cell 1 or cell 2; no cell edge band is allocated to cell edge terminals in cell 3) is somewhat shorter and may be e.g. two TTI. The third allocation time period t3 (a cell edge band is only allocated to cell edge terminals located in cell 2 and cell 3; no cell edge band is allocated to cell edge terminals in cell 1) is short, e.g. only one TTI. Thereby, a frequency resource allocation is enabled in accordance with the requirements of uplink data transmission depending on the larger number of cell edge terminals in cell 3 and the even larger number of cell edge terminals in cell 1. In cell 2, 25% of the available time-frequency resources are allocated to cell edge terminals, in cell 3 about 33% of the available time-frequency resources are allocated to cell edge terminals and in cell 1 with the largest number of cell edge users about 42% of the available time-frequency resources are allocated to cell edge terminals.

Alternatively or additionally, the section of the available frequency bandwidth that is allocated as cell edge band may be determined responsive to cell statistic parameters and/or SON and may be varied. E.g. while cell 1 with a large number of cell edge terminals may be allocated 80% of the available frequency bandwidth during a particular allocation time period, cell 3 with a significantly lower number of cell edge terminals may be allocated 20% of the available frequency bandwidth.

In addition to FIGS. 6 and 7, FIG. 8 shows a flowchart of an example method for cell edge band frequency allocating within a telecommunication system. The telecommunication system comprises a first node serving a first cell, a second node serving a second cell and a third node serving a third cell, whereby each of the three cells have been allocated the same frequency bandwidth for uplink transmission of terminals within the respective cell. In this example, cell 1, 2 and 3 are neighboring cells or cells with potentially interfering uplink transmission. The method may alternatively be performed within the first node only or within the first and second node only. According to the example method, during a first allocation time period t1, a first frequency band f1 within the frequency bandwidth fB is allocated (811) as a cell edge band for uplink transmission for cell 1, a second frequency band different from the first frequency band and within the frequency bandwidth fB is allocated (814) as cell edge band for uplink transmission for cell 2 and no cell edge band is allocated (817) for cell 3. During a second allocation time period t2, the second frequency band f2 is allocated (812) as cell edge band for uplink transmission for cell 1, the first frequency band f1 is allocated (818) as cell edge band for uplink transmission for cell 3 and no cell edge band is allocated (815) for uplink transmission for cell 2. During a third allocation time period t3, the first frequency band f1 is allocated (816) as cell edge band for uplink transmission for cell 2, the second frequency band f2 is allocated (819) as cell edge band for uplink transmission for cell 3 and no cell edge band for uplink transmission is allocated (813) for cell 1. After the third allocation time period t3, the method is repeated again starting from the procedure described for the first allocation time period t1.

The order of the cell edge band allocation sequence illustrated in FIG. 8 is only an example. In order to reduce cell edge interference it is preferred that during one and the same allocation time period no overlapping frequencies are allocated as cell edge band for different cells. However, whether the first frequency band is allocated as cell edge band for uplink transmission for cell 1, cell 2 or cell 3 during the first allocation time interval is of no importance as long as the above-mentioned criterion is fulfilled. Equally, it is of no importance whether the second frequency band is allocated as cell edge band for uplink transmission for cell 1, 2 or 3 during the first or second allocation time interval. As long as no overlapping frequencies are allocated as cell edge band for different potentially interfering cells within the same allocation time period, the sequence of allocation of frequency bands as cell edge bands for uplink transmission is of no importance.

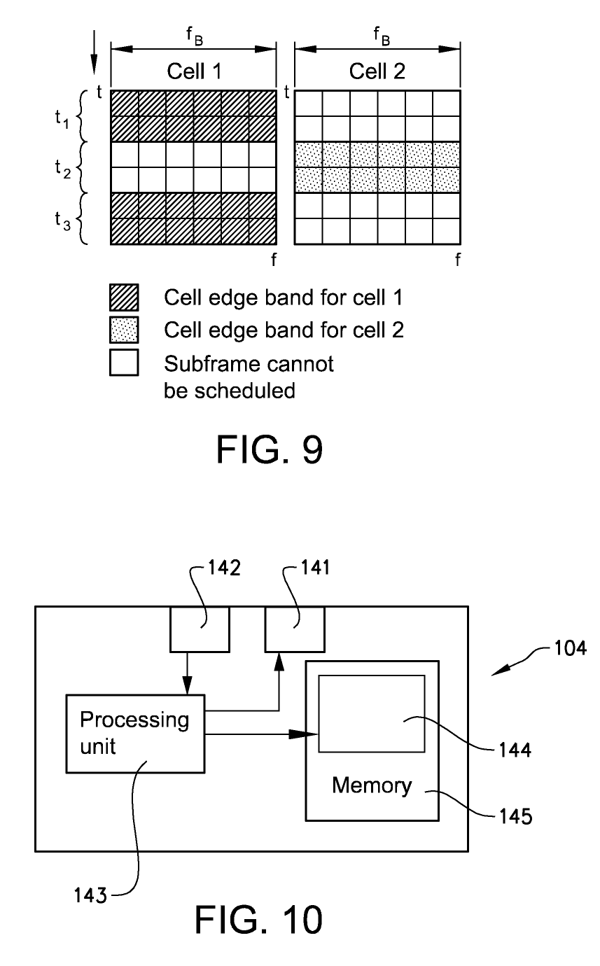

Embodiments of the present disclosure may advantageously be employed in heterogynous networks. Heterogynous networks (HetNets) employ network nodes with different wireless coverage zones, e.g. any combination of networks using macrocells, femtocells, microcells and/or picocells. An example of use of the present disclosure in connection with a network comprising a macro cell and a pico cell within the coverage area of the macro cell is illustrated in FIG. 9. In the example given in FIG. 9, the pico cell and the macro cell are completely overlapped. Whenever there is a transmission in any of the two cells, it will cause interference in the respective other cell. Therefore, in this example all terminals within the coverage area of both the pico cell and the macro cell can be considered as cell edge users.

In order to reduce or avoid interference between the macro cell and the pico cell, during a first allocation time period t1 a first frequency band f1, namely in this case the entire frequency bandwidth fB, is allocated as cell edge band for uplink transmission for the first cell. During the first allocation time period t1, no cell edge band for uplink transmission is allocated for the second cell. It is in this regard of no importance whether the first cell or the second cell is the macro cell or the pico cell, respectively, as the same method may equally be employed in both cases. During a second allocation time period t2, the second frequency band f2 is allocated as cell edge band for uplink transmission for the second cell. During that second allocation time period t2, no cell edge band for uplink transmission is allocated for the first cell. It should be noted that in this specific example due to the overlapping coverage of the two cells no differentiation is made between the terminals within the coverage area of any of those two cells, but all terminals are considered to be cell edge terminals.

FIG. 10 illustrates an exemplifying network node comprising means for implementing embodiments of the methods. The network node 104 comprises a processing unit 143, e.g. a central processing unit (CPU), microcontroller, digital signal processor (DSP), etc., capable of executing software instructions stored in a computer program product 145 e.g. in the form of a memory. The processing unit 143 is connected to an input device 142 of the network node 104, by means of which it receives information from a wireless terminal. The processing unit 143 is connected to an output device 141 by means of which it transmits information to the wireless terminal.

It is noted that the network node 104 may comprise further components and/or circuitry not illustrated in the figure.

The described methods and algorithms or parts thereof for cell edge band allocation may be implemented e.g. by software and/or application specific integrated circuits in the processing unit 143. To this end, the network node 104 may further comprise a computer program 144 stored on the computer program product 145.

The processing unit 143 is configured to allocate a first frequency band within the first frequency bandwidth as a cell edge band for uplink transmission during a first allocation time period and to allocate a second frequency band different from the first frequency band within the first frequency bandwidth as the cell edge band for uplink transmission during a second allocation time period.

The processing unit may additionally be configured to determine the duration of the first allocation time period and/or the second allocation time period responsive to at least a first cell statistic parameter and/or determine the first frequency band and/or the second frequency band responsive to at least a second cell statistics parameter.

With reference still to FIG. 10, the present disclosure also provides the computer program 144 for cell edge band allocation. The computer program 144 comprises computer program code which when run on the network node 104, and in particular the processing unit 143 thereof, causes the network node 104 to perform any of the methods as described in this disclosure.

A computer program product 145 is also provided comprising the computer program 144 and computer readable means on which the computer program 144 is stored. The computer program product 145 may be any combination of read and write memory (RAM) or read only memory (ROM). The computer program product 145 may also comprise persistent storage, which, for example can be any single one or combination of magnetic memory, optical memory, or solid state memory.

1. Method in a first node of a wireless telecommunication system, the first node serving terminals located within a first cell of the telecommunication system and being allocated a first frequency bandwidth for uplink transmission of the terminals within the cell, the method comprising
allocating a first frequency band within the first frequency bandwidth as a cell edge band for uplink transmission during a first allocation time period;
allocating a second frequency band different from the first frequency band within the first frequency bandwidth as the cell edge band for uplink transmission during a second allocation time period.

2. Method according to claim 1, whereby the first allocation time period is a first number of Time Transmission Intervals, TTI, and the second allocation time period is a second number of TTI.

3. Method according to claim 2, whereby the first allocation time period and the second allocation time period are consecutive.

4. Method according to claim 1, wherein during a third allocation time period no uplink transmission frequency band within the first frequency bandwidth is allocated as cell edge band for uplink transmission.

5. Method according to claim 4, whereby the third allocation time period is intermediate to the first allocation time period and the second allocation time period.

6. Method according to claim 4, whereby the third allocation time period is consecutive to the second allocation time period.

7. Method according to claim 1, whereby the first or the second frequency band comprises a lower part of the first frequency bandwidth and the first or the second frequency band comprises an upper part of the first frequency bandwidth, respectively.

8. Method according to claim 7, whereby the lower part is a lower half of the first frequency bandwidth and the upper part is the upper half of the first frequency bandwidth.

9. Method according to claim 1 further comprising
determining the duration of the first allocation time period and/or the second allocation time period responsive to at least a first cell statistic parameter.

10. Method according to claim 1 further comprising
determining the first frequency band and/or the second frequency band responsive to at least a second cell statistics parameter.

11. Method according to claim 1, whereby the first frequency bandwidth extends between a lowest frequency value and a highest frequency value and whereby the first frequency band or the second frequency band comprises the lowest frequency value and the first frequency band or the second frequency band comprises the highest frequency value, respectively.

12. A method in a telecommunication system, the telecommunication system comprising
a first node serving terminals located within a first cell of the telecommunication system and being allocated a first frequency bandwidth for uplink transmission of the terminals within the first cell,
a second node serving terminals located within a second cell of the telecommunication system and being allocated the first frequency bandwidth for uplink transmission of the terminals within the second cell;
comprising
during a first allocation time period,
allocating a first frequency band within the first frequency bandwidth as cell edge band for uplink transmission for terminals located within the first cell and close to a cell boarder of the first cell;
allocating a second frequency band different from the first frequency band within the first frequency bandwidth as cell edge band for uplink transmission for terminals within the second cell and close to a cell boarder of the second cell;
during a second allocation time period
allocating the second frequency band as cell edge band for uplink transmission for terminals located within the first cell and close to a cell boarder of the first cell.

13. Method according to claim 12, whereby the telecommunication system comprises a third node serving terminals located within a third cell of the telecommunication system and being allocated a first frequency bandwidth for uplink transmission of the terminals within the third cell, the method further comprising
during the second allocation time period
allocating the first frequency band as cell edge band for uplink transmission for terminals located within the third cell and close to a cell boarder of the first cell and
during a third allocation time period
allocating the second frequency band as cell edge band for uplink transmission for terminals located within the third cell and close to a cell boarder of the third cell and
allocating the first frequency band as cell edge band for uplink transmission for terminals located within the second cell and close to a cell boarder of the second cell.

14. Method according to claim 12, whereby the first frequency bandwidth extends between a lowest frequency value and a highest frequency value and whereby the first frequency band or the second frequency band comprises the lowest frequency value and the first frequency band or the second frequency band comprises the highest frequency value, respectively.

15. A network node within a telecommunication system, the network node comprising a processing unit and a memory, the processing unit being configured to:
allocate a first frequency band within the first frequency bandwidth as a cell edge band for uplink transmission during a first allocation time period;
allocate a second frequency band different from the first frequency band within the first frequency bandwidth as the cell edge band for uplink transmission during a second allocation time period.

16. (canceled)
